(19) United States
(12) Patent Application Publication
(10) Pub. No.: US 2005/0015373 A1
(43) Pub. Date: Jan. 20, 2005

(54) Object management system and method

(76) Inventor: Kuang Yang, Taipei (TW)

Correspondence Address: RABIN & Berdo, PC, 1101 14TH STREET, NW, SUITE 500, WASHINGTON, DC, 20005, US

(21) Appl. No.: 10/712,089

(22) Filed: Nov. 14, 2003

(30) Foreign Application Priority Data
Jul. 16, 2003 (TW) 92119370

(51) Int. Cl. G06F 7/00

(52) U.S. Cl. 707/9

(57) ABSTRACT

An object management system and method. The system includes an object access interface, a resource management module, an access management module and an object management module. The object access interface receives an access request, from an entity, including at least identification of the entity, a source port, object information and access content. The resource management module assigns a command handler to the access request. The access management module determines authority for the access request. The object management module performs a procedure corresponding to the access content on the object designated by the object information. After the procedure is finished, the command handler is released.

### BACKGROUND OF THE INVENTION

1. Field of the Invention

The present invention relates to an object management system and method, and particularly to a system and method of managing object exchange between entities via a platform.

2. Description of Related Art

With the wide use of computer systems, specific functions and systems are developed for different tasks. For example, a computer host of an enterprise can comprise a workflow management system, a manufacturing planning system, an enterprise resource planning (ERP) system and others to perform related operations inside the enterprise.

Since these systems may cooperatively work and use common data, the systems often need to exchange objects or messages. FIG. 1 illustrates object exchange in a conventional system. As shown in FIG. 1, if all systems (system A 11, system B 12, system C 13, system D 14 and system E 15) need to exchange objects, the message flow is complex. If more systems are installed in the computer host, the object exchange between systems will become more complicated.

Further, when systems of different computer hosts need to exchange objects through a network, the bandwidth of the network is significantly reduced, resulting in instability of cooperation. In addition, when systems are removed from or added to the work environment, the object exchange interface and mechanism of other systems communicating therewith require redesign, thereby increasing the difficulty of system design, expansion and maintenance.

### SUMMARY OF THE INVENTION

The present invention provide a system and method of managing object exchange between entities via a platform.

The present invention provides an object management system and method. The system includes an object access interface, a resource management module, an access management module and an object management module.

The object access interface receives an access request, from at least one entity, including at least identification of the entity, a source port, object information and access content. The resource management module assigns a command handler to the access request. The access management module determines authority for the access request according to the identification and the source port. The object management module performs a procedure corresponding to the access content on the object designated by the object information. After the procedure is finished, the command handler is released.

In addition, if the resource management module has no available command handler might be assigned to the access request, the access request is rejected or waits until one command handler is available.

The object management method according to the present invention first receives an access request from an entity, wherein the access request includes at least identification of the entity, a source port, object information and access content. Then, a command handler is assigned to the access request. Thereafter, authority for the access request is determined according to the identification and the source port. After, a procedure corresponding to the access content is performed on the object designated by the object information. After the procedure is finished, the command handler is released.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating object exchange in a conventional system;

FIG. 2 is a schematic diagram illustrating object exchange according to the present invention;

FIG. 3 is a schematic diagram illustrating the system architecture of the object management system according to the present invention;

FIG. 4 is a schematic diagram illustrating the relationship between access ports according to the invention;

FIG. 5 is a schematic diagram illustrating the components of the object management module according to the present invention;

FIG. 6 is a flowchart showing the process of object writing according to the present invention;

FIG. 7 is a flowchart showing the process of object reading according to the present invention;

FIG. 8 is a flowchart showing the process of object removal according to the present invention; and

FIG. 9 is a flowchart showing the process of object retrieval according to the present invention.

### DETAILED DESCRIPTION OF THE INVENTION

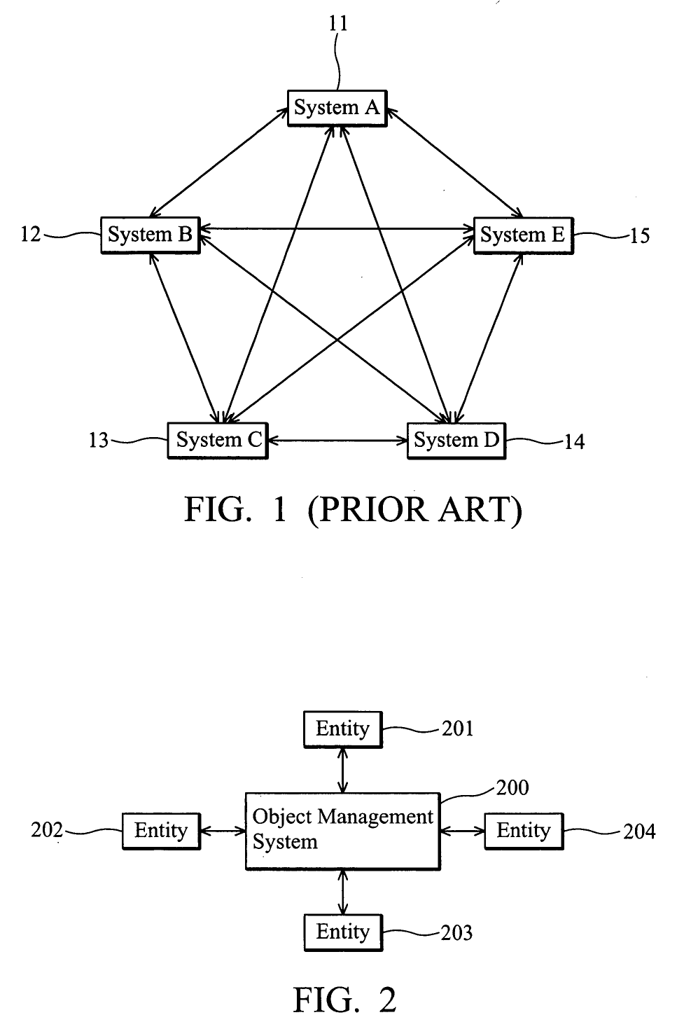

FIG. 2 is a schematic diagram illustrating object exchange according to the present invention. As shown in FIG. 2, entities 201, 202, 203 and 204 may use the object management system 200 of the present invention as a platform to exchange and transmit objects. It should be noted that the entities might be users, application systems, software components, or others. Compared to FIG. 1, the present invention may significantly reduce message flow between entities, and thus the complexity of the work environment is reduced.

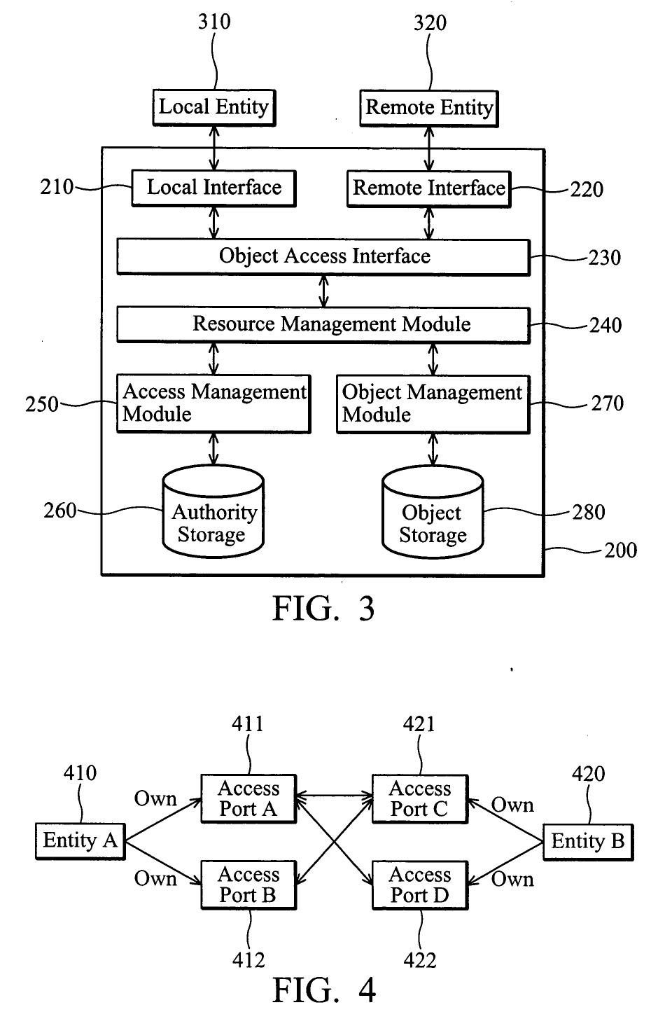

FIG. 3 illustrates the system architecture of the object management system according to the present invention.

The object management system 200 according to the present invention includes a local interface 210, a remote interface 220, an object access interface 230, a resource management module 240, an access management module 250, authority storage 260, an object management module 270 and object storage 280.

The local interface 210 provides access service for at least one local entity 310, such those on the computer host of the object management system 200. The local entity 310 may directly use resources, such as memory and hard disk of the computer host. The remote interface 220 provides access for at least one remote entity 320, in which the remote entity 320 communicates with the object management system 200 via a network. At the time, the remote interface 220 is responsible for related operations of network transmission, such as packet combination and disassembly.

After the local interface 210 and the remote interface 220 receive the access request from the local entity 310 and the remote entity 320, and perform related operations, the received access request is forwarded to the object access interface 230. The object access interface 230 may be an interface to handle access requests from the local entity 310 and the remote entity 320.

The access request may include identification of the entity, a source port (source access port), object information, access content, and a destination port, selectively. It should be noted that each entity might have a plurality of access ports, each access port having respective authority for transmitting objects to a specific access port. For example, in FIG. 4, the entity A 410 owns the access port A 411 and the access port B 412, the entity B 420 owns the access port C 421 and the access port D 422, in which the access port A 411 has the authority to transmit objects to the access port C 421 and the access port D 422, the access port B 412 has the authority to transmit objects to the access port C 421, the access port C 421 has the authority to transmit objects to the access port A 411 and the access port B 412, and the access port D 422 has the authority to transmit objects to the access port A 411.

The resource management module 240 manages the resources of the computer host, the module 240 includes a predetermined number of command handlers, and assigns one thereof to the access request if the access request is received by the object access interface 230. After the procedure corresponding to the access request is finished, the command handler is released. It should be noted that if all of the command handlers are assigned to different access requests, a new access request received by the object access interface 230 is rejected or waits. Once one assigned command handler is released, the resource management module 240 may assign the released command handler to the new access request.

The access management module 250 manages authority for the object management system 200, each access port, and object transmission between the access ports for each entity. The authority information is stored in the authority storage 260.

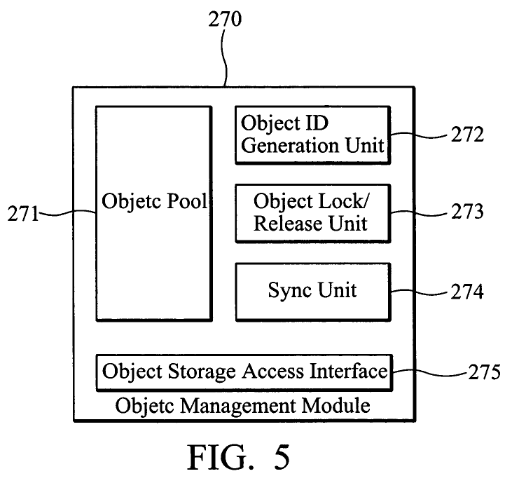

The object management module 270 may perform procedures corresponding to the access content on the object designated by the object information according to authority for the access request. FIG. 5 illustrates the components of the object management module 270 according to the present invention. As shown in FIG. 5, the object management module 270 at least includes an object pool 271, an object ID (identification) generation unit 272, an object lock/release unit 273, a sync unit 274 and an object storage access interface 275.

All objects in the object management system 200 are stored in the object pool 271, in which the object pool 271 may be the memory of the computer host. When a new object enters the object management system 200, the object ID generation unit 272 generates a unique ID for the object for access identification and determination. After the object is retrieved by one entity, the object lock/release unit 273 locks the object, such that the other entities cannot access the locked object (in other words, the object is not available for other entities). After the entity finishes handling the object or a preset time passes, the object lock/release unit 273 releases the object. If the work environment includes several object management systems, the sync unit 274 may synchronously update the variation of the objects in the object pool 271 to the other object management systems. The object storage access interface 275 is an interface for the object management module 270 to access the object storage 280.

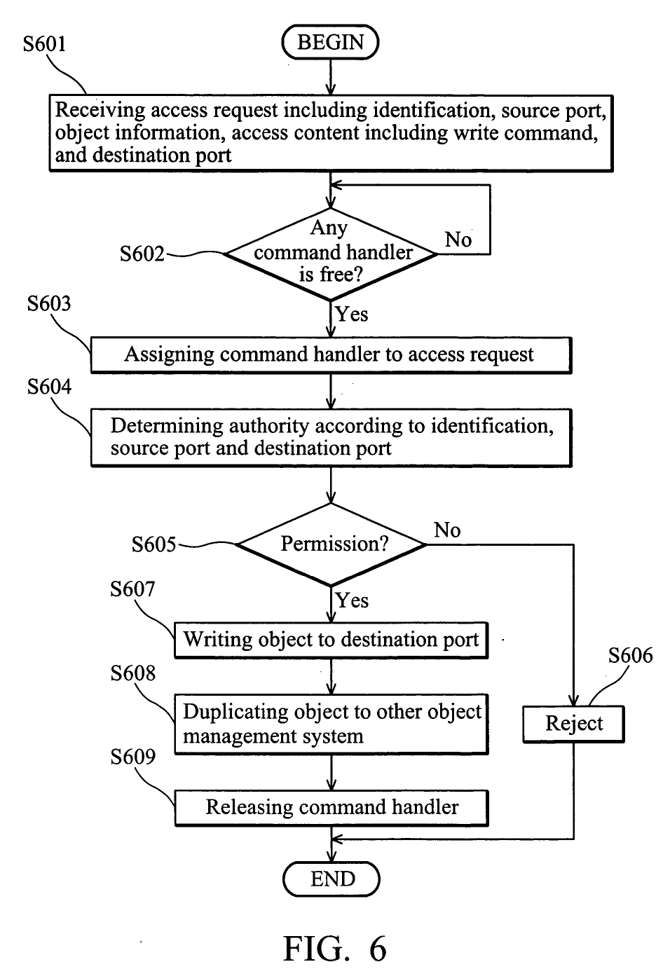

FIG. 6 shows the process of object writing according to the present invention. First, in step S601, the object access interface 230 receives an access request from the entity (local entity 310 or remote entity 320) via the local interface 210 or the remote interface 220. The access request includes identification of the entity, a source port, object information, access content including a write command, and a destination port. Then, in step S602, the resource management module 240 checks whether any command handler is available. If all of the command handlers have been assigned (No in step S602), the flow stays in step S602 until a command handler is released. Otherwise (Yes in step S602), in step S603, the resource management module 240 assigns a command handler to the access request.

Thereafter, in step S604, the access management module 250 retrieves authority (or determines authority) for the access request from the authority storage 260 according to the identification of the entity, the source port and the destination port. If the access request is not permitted (No in step S605), in step S606, the access request of the entity is rejected. Otherwise (Yes in step S605), in step S607, the object ID generation unit 272 generates object ID for the object corresponding to the object information, and the object management module 270 writes the object into the destination port in the object pool 271. At the same time, in step S608, the sync unit 274 synchronously duplicates the object to the other object management systems.

It should be noted that if the access content includes a permanent write command, the object management module 200 further writes the object to the object storage 280. After the write operation of the object finishes, in step S609, the assigned command handler is released.

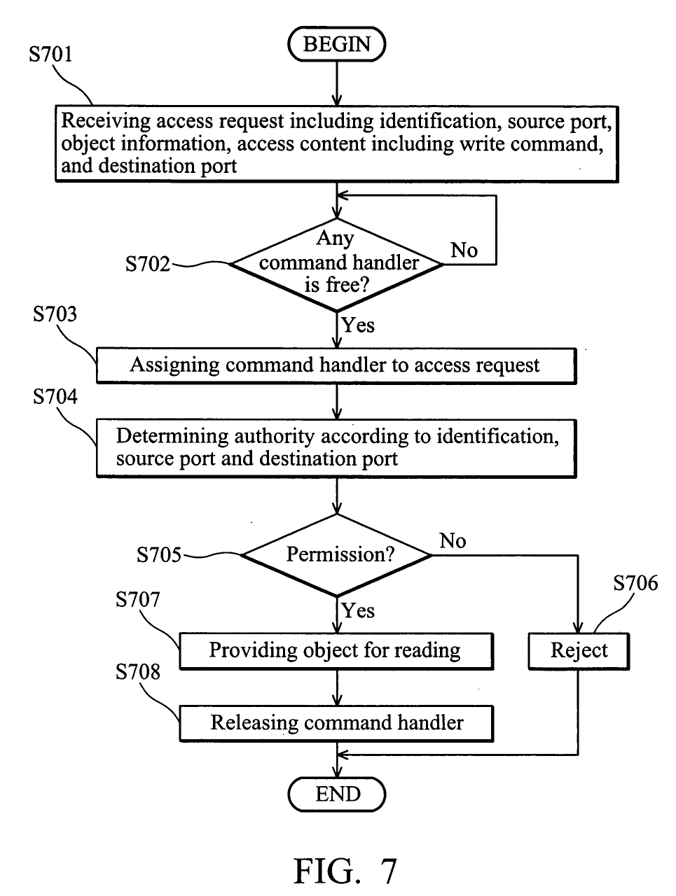

FIG. 7 shows the process of object reading according to the present invention. First, in step S701, the object access interface 230 receives an access request, from the entity (local entity 310 or remote entity 320) via the local interface 210 or the remote interface 220, including identification of the entity, a source port, object information, and access content including a read command. Then, in step S702, the resource management module 240 checks whether any command handler is available. If all of the command handlers have been assigned (No in step S702), the flow stays in step S702 until a command handler is released. Otherwise (Yes in step S702), in step S703, the resource management module 240 assigns a command handler to the access request.

Thereafter, in step S704, the access management module 250 retrieves authority for the access request from the authority storage 260 according to the identification of the entity and the source port. If the access request is not permitted (No in step S705), in step S706, the access request of the entity is rejected. Otherwise (Yes in step S705), in step S707, the object corresponding to the object information is provided to the entity for reading. After the read operation of the object finishes, in step S708, the assigned command handler is released.

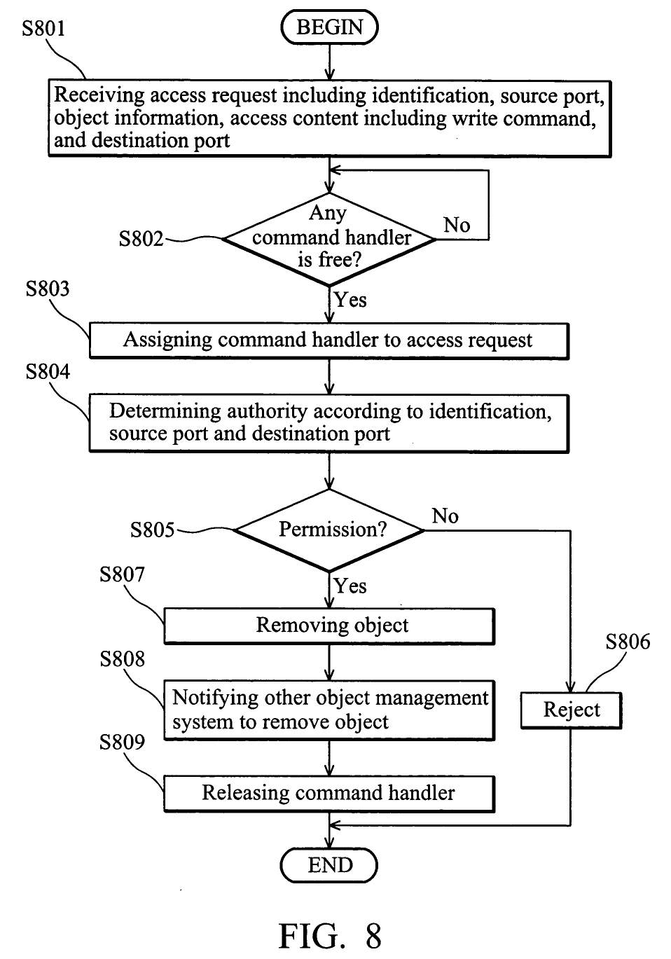

FIG. 8 shows the process of object removal according to the present invention. First, in step S801, the object access interface 230 receives an access request from the entity (local entity 310 or remote entity 320) via the local interface 210 or the remote interface 220, including identification of the entity, a source port, object information, and access content including a remove command. Then, in step S802, the resource management module 240 checks whether any command handler is available. If all of the command handlers have been assigned (No in step S802), the flow stays in step S802 until a command handler is released. Otherwise (Yes in step S802), in step S803, the resource management module 240 assigns a command handler to the access request.

Thereafter, in step S804, the access management module 250 retrieves authority for the access request from the authority storage 260 according to the identification of the entity and the source port. If the access request is not permitted (No in step S805), in step S806, the access request of the entity is rejected. Otherwise (Yes in step S805), in step S807, the object corresponding to the object information is removed. At the same time, in step S808, the sync unit 274 synchronously notifies the other object management systems to remove the object. After the remove operation of the object finishes, in step S809, the assigned command handler is released.

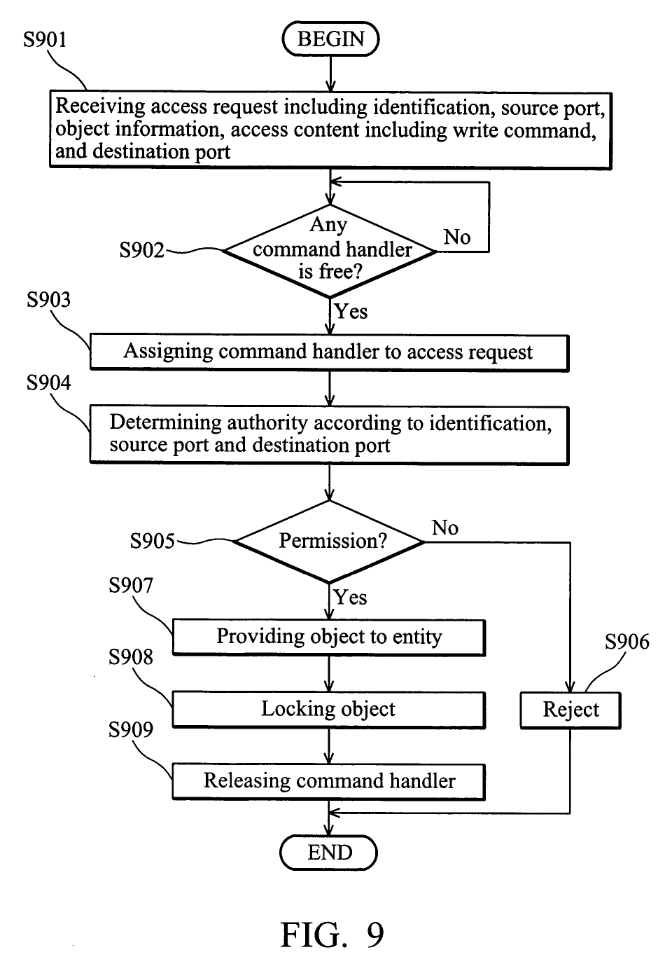

FIG. 9 shows the process of object retrieval according to the present invention. First, in step S901, the object access interface 230 receives an access request from the entity (local entity 310 or remote entity 320) via the local interface 210 or the remote interface 220, including identification of the entity, a source port, object information, and access content including a retrieve command. Then, in step S902, the resource management module 240 checks whether any command handler is available. If all of the command handlers have been assigned (No in step S902), the flow stays in step S902 until a command handler is released. Otherwise (Yes in step S902), in step S903, the resource management module 240 assigns a command handler to the access request.

Thereafter, in step S904, the access management module 250 retrieves authority for the access request from the authority storage 260 according to the identification of the entity and the source port. If the access request is not permitted (No in step S905), in step S906, the access request of the entity is rejected. Otherwise (Yes in step S905), in step S907, the object corresponding to the object information is provided to the entity. At the same time, in step S908, the object lock/release unit 273 locks the object, disabling access from other entities. It should be noted that if the entity finishes handling the object, the object lock/release unit 273 releases the object. In addition, if the access request has a preset time limit, the object lock/release unit 273 releases the object after the preset time. After the retrieval operation of the object finishes, in step S909, the assigned command handler is released.

As a result, the object management system and method according to the present invention provides object exchange and transmission between systems or entities via a platform, thereby reducing message flow and complexity of the work environment. In addition, when systems are removed from or added to the work environment, the object exchange interface and mechanism of existing systems does not require removal or redesign, thereby reducing the difficulty of system design, expansion and maintenance.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. An object management system, comprising:
an object access interface to receive an access request from at least one entity, wherein the access request includes at least identification of the entity, a source port, object information and access content;
a resource management module to assign a command handler to the access request;
an access management module to determine authority of the access request according to the identification and the source port; and
an object management module to perform a procedure corresponding to the access content on an object corresponding to the object information,
wherein, when the object management module finishes the procedure, the command handler is released.

2. The system as claimed in claim 1 wherein, when the access request further includes a destination port and the access content further includes a write command, the object management module writes the object to the destination port according to the authority and the write command.

3. The system as claimed in claim 2 wherein, when the access content further includes a permanent write command, the object management module further writes the object to an object storage according to the permanent write command.

4. The system as claimed in claim 2 wherein the object management module further duplicates the object to a second object management module.

5. The system as claimed in claim 1 wherein the access content includes a read command, and the object management module provides the object to the entity for reading according to the authority and the read command.

6. The system as claimed in claim 1 wherein the access content includes a remove command, and the object management module removes the object according to the authority and the remove command.

7. The system as claimed in claim 6 wherein the object management module further notifies a second object management module to remove the object.

8. The system as claimed in claim 1 wherein the access content includes a retrieve command, and the object management module provides the object to the entity according to the authority and the retrieve command, and locks the object such that the object is not available for any other entity.

9. The system as claimed in claim 8 wherein the object management module further releases the object after a preset time.

10. An object management method, comprising the steps of:
receiving an access request from at least one entity, the access request including at least identification of the entity, a source port, object information and access content;
assigning a command handler to the access request;
determining authority of the access request according to the identification and the source port;
performing a procedure corresponding to the access content on an object corresponding to the object information; and
releasing the command handler when the procedure finishes.

11. The method as claimed in claim 10 wherein, when the access request further includes a destination port and the access content further includes a write command, the method further comprises writing of the object to the destination port according to the authority and the write command.

12. The method as claimed in claim 11 wherein, when the access content further includes a permanent write command, the method further comprises writing of the object to an object storage, according to the permanent write command.

13. The method as claimed in claim 11 further comprising duplication of the object to a second object management module.

14. The method as claimed in claim 10 wherein, when the access content includes a read command, the method further comprises provision of the object to the entity for reading according to the authority and the read command.

15. The method as claimed in claim 10 wherein, when the access content includes a remove command, the method further comprises removal of the object according to the authority and the removal command.

16. The method as claimed in claim 15 further comprising notification of a second object management module to remove the object.

17. The method as claimed in claim 10 wherein, when the access content includes a retrieve command, the method further comprises provision of the object to the entity according to the authority and the retrieve command, and locking of the object such that the object is unavailable for any other entity.

18. The method as claimed in claim 17 further comprising release of the object after a preset time.

19. An object management system, comprising:
an object access interface to receive an access request from at least one entity, the access request including at least identification of the entity, a source port, a destination port, object information and access content including a write command;
a resource management module to assign a command handler to the access request;
an access management module to determine authority of the access request according to the identification and the source port; and
an object management module to write an object corresponding to the object information to the destination port according to the authority and the write command,
wherein after the object management module writes the object to the destination port, the command handler is released.

20. The system as claimed in claim 19 wherein the object management module further duplicates the object to a second object management module.
